(19) United States
(12) Patent Application Publication
(10) Pub. No.: US 2026/0175340 A1
(43) Pub. Date: Jun. 25, 2026

(54) METHOD FOR COMPENSATING FOR MEASUREMENT ERRORS WHEN MEASURING TOOLS OR WORKPIECES, IN PARTICULAR IN AUTOMATED PROCESSES, FOR EXAMPLE, IN A MOUNTING DEVICE, IN PARTICULAR A SHRINK DEVICE, FOR AUTOMATED CHUCKING AND UNCHUCKING OF A TOOL IN A TOOLHOLDER, MEASURING DEVICE FOR MEASURING TOOLS OR WORKPIECES, AND MOUNTING DEVICE, IN PARTICULAR SHRINK DEVICE, FOR AUTOMATED CHUCKING AND UNCHUCKING OF A TOOL IN A TOOLHOLDER

(71) Applicant: Haimer GmbH, Hollenbach-Igenhausen (DE)

(72) Inventor: Andreas Haimer, Hollenbach-Igenhausen (DE)

(21) Appl. No.: 19/417,582

(22) Filed: Dec. 12, 2025

(30) Foreign Application Priority Data
Dec. 23, 2024 (DE) 10 2024 139 625.3

(51) Int. Cl. B23Q 3/155; B23Q 3/18

(52) U.S. Cl. CPC B23Q 3/1552; B23Q 3/18

(57) ABSTRACT

A method compensates for measurement errors when measuring tools or workpieces, in automated processes, for example, in a mounting device, such as a shrink device, for automated chucking and unchucking of a tool in a toolholder. To compensate for measurement errors when measuring tools or workpieces, a point distinguishing the tool or the workpiece on the tool or workpiece, in particular a highest point of the tool or workpiece with respect to the longitudinal axis of the tool or workpiece, is measured. The tool or workpiece is rotated by a specifiable rotational angle around its longitudinal axis from a defined starting rotational position. A mean value, in particular an arithmetic mean value, is then determined from the measured values of the measured value course measured. An error-compensated value for the point distinguishing the tool or the workpiece is determined using the determined mean value, in particular a determined arithmetic mean.

### CROSS-REFERENCE TO RELATED APPLICATION

This application claims the priority, under 35 U.S.C. § 119, of German Patent Application DE 10 2024 139 625.3, filed Dec. 23, 2024; the prior application is herewith incorporated by reference in its entirety.

### FIELD AND BACKGROUND OF THE INVENTION

The invention relates to a method for compensating for measurement errors when measuring tools or workpieces, in particular in automated processes, for example, in a mounting device, in particular a shrink device, for automated chucking and unchucking of a tool in a toolholder, to a measuring device for measuring tools or workpieces, and to a mounting device, in particular shrink device, for automated chucking and unchucking of a tool in a toolholder.

A shrink device for automated shrinking and unshrinking of a tool in a toolholder comprising a measuring device for measuring tools is known from non-prosecuted German patent application DE 10 2024 122 028 A1, corresponding to U.S. patent publication No. 2025/0073830. With the devices of the product line “UNO” or the product line “VIO” from Haimer, preset devices are known, i.e. devices for measuring a tool or a tool in a toolholder (complete/entire tool), also comprising a measuring device for measuring tools.

### Shrink Device/Cell

Widening toolholders, which hold a shaft of a tool, in particular a rotation tool, such as a drill, a milling cutter, or a grinding tool, in a press fit in a central receptacle opening of the toolholder, in the area of this receptacle opening by heating in order to be able to insert or remove the shaft of the tool, is known (thermal shrinking or unshrinking or in short only shrinking or unshrinking).

So-called shrink devices are typically used for this purpose—and induction heating units installed therein are used for the heating of the toolholder, with which transformer eddy currents are induced in the toolholder by means of an induction coil assembly.

In the heating phase, which only lasts a few seconds, the toolholder (located in the shrink device) is heated to several hundred degrees Celsius in the area of the receptacle opening (, wherein the area of the receptacle opening of the toolholder is thus widened—and the shaft of the tool can thus be inserted there or the tool can be removed).

To shorten the cooling phase of the toolholder (and possibly also increase the operational safety in shrinking), it is subsequently cooled by blowing an air flow against it or by means of a cooling collar through which coolant flows.

In the preceding years, the shrinking process has also been substantially automated by advancing automation of industrial processes, wherein not only the actual shrinking procedure by the shrink device, as described, has been automated, but rather also processes before and after the actual shrinking procedure, such as the supply and the removal of toolholder and tool to and from the shrink device or also the cooling (of a toolholder after the shrinking), balancing, and/or presetting—as integrated required processes in the automated shrinking in the overall process of industrially automated manufacturing.

I.e. by means of such an automated shrink device, which is often or typically also only called an automated shrink cell, or the mounting device/shrink device for the automated chucking and unchucking/shrinking/unshrinking of a tool in a toolholder, equipping a toolholder with a tool or a tool change in a toolholder can be carried out in an automated manner nearly without manual intervention—in the overall process of automated production of workpieces.

Once again for clarification—shrink device (for automated shrinking and unshrinking of a tool in a toolholder) or (automated) shrink cell means a complex industrial system which has—as an entirely essential component—the shrink device—for the (actual) shrinking/unshrinking of tools in toolholders—but in addition a large number of different other important components, such as handling devices or industrial robots/arms and/or conveyor devices/belts, which effectuate processes before and after the (actual) shrinking in the shrink device and thus enable a complex automated (overall) process—as an integrated required process in the automated shrinking in the overall process of industrially automated manufacturing.

Such a shrink device for automated shrinking and unshrinking of a tool in a toolholder or an automated shrink cell is known from non-prosecuted German patent application DE 10 2024 122 028 A1, which was already cited.

### Presetting

Furthermore, it is typical, possibly, for example, in an automated manner in such an above-mentioned shrink device for the automated shrinking and unshrinking of a tool in a toolholder or automated shrink cell—or also independently thereof, to measure a complete tool made up of a toolholder and a tool chucked, for example, shrunk, in the toolholder, for example, a shrunk milling tool or chucked cutting tool, before the coupling with a machine tool, for example, designed as a CNC processing machine, by means of a device for measuring a tool, also referred to in short only as a “presetting device” (“presetting”).

The (geometric) dimensions of the tool or complete tool determined using the presetting device are then provided to the machine tool or used therein to optimize the workpiece processing in the machine tool.

It is ensured in particular by the presetting that parts of the tool processing a workpiece, such as a cutting-edge of a cutting/milling tool, have position dimensions acceptable for the planned machining of the workpiece on the machine tool. Expressed in simplified and general terms, tools are checked and inspected for dimensional accuracy of all relevant dimensions and features.

By means of such a presetting device, in this case in particular the length of the complete tool, the diameter and/or the blade shape of the chucked tool or cutting/milling tool—and possibly various further dimensions of the or in the tool or complete tool are measured.

If these data are directly relevant for the quality of the workpiece processing of the workpiece in the machine tool, the tool measurement in the presetting device has to take place with great (repetition) accuracy.

Such a measuring device or such a presetting device is known, for example, by way of the above-mentioned presetting device of the production line “UNO” or the production line “VIO” from Haimer.

### Disadvantage in the Prior Art

Both in the shrink device for automated shrinking and unshrinking of a tool in a toolholder or automated shrink cell and also in the device for measuring a tool or a tool in a toolholder (complete tool) or presetting device and also in such measuring devices for measuring tools, the quality/accuracy of the process/result is decisively dependent on the quality and accuracy of the measuring of the tool (or complete tool) or of measuring devices/camera systems used therein.

Measurement errors and/or measurement inaccuracies in the measurement can have the result that prepared complete tools do not have required/desired tolerances, which in turn as a result leads to inaccuracies in the manufacturing of workpieces (by means of such complete tools).

### SUMMARY OF THE INVENTION

It is the object of the invention to provide an accurate and/or preferably error-free measurement of objects, such as tools or also workpieces, in particular in automated processes, for example, in a shrink device for automated shrinking and unshrinking of a tool in a toolholder and/or in devices for measuring a tool or a tool in a toolholder (complete tool).

This object is achieved by a method for compensating for measurement errors when measuring tools or workpieces, in particular in automated processes, for example, in a mounting device, in particular a shrink device, for automated chucking and unchucking of a tool in a toolholder, a measuring device for measuring tools or workpieces, and a mounting device, in particular a shrink device, for automated chucking and unchucking of a tool in a toolholder—having the features of the respective independent claim.

Advantageous refinements of the invention are the subject matter of dependent claims and the following description—and relate both to the method and to the devices.

Terms which are possibly used such as above, below, front, rear, left, or right—if not explicitly defined otherwise—are to be understood according to the typical understanding—also in consideration of the present figures. Terms such as radial and axial, if used and not explicitly defined otherwise, are to be understood in relation to center axes or axes or symmetry of parts/components described here—also in consideration of the present figures.

The term “essentially”—if used—can be understood to mean (according to the understanding of the highest court) that it refers to “a practically still substantial amount”. Possible deviations from the exact implied by this concept can thus result without intention (thus without functional reason) due to manufacturing or mounting tolerances or the like.

In the method for compensating for measurement errors when measuring tools or workpieces, a point distinguishing the tool or workpiece is measured on the tool or workpiece, in particular a highest point of the tool or workpiece with respect to the longitudinal axis of the tool or workpiece. In this case, the tool or workpiece is rotated from a defined starting rotational position by a specifiable rotational angle around its axis of rotation.

Furthermore, a mean value is determined in the measured values of the measured value profile which is measured. The mean value can be determined by a suitable mathematical method. For example, it can be the arithmetic mean, the geometrical mean, or the median. Preferably, reference is to be made to the arithmetic mean, which is not to exclude other methods for averaging, however.

Using the determined mean value, in particular the arithmetic mean, an error-compensated value or measured value is then determined for the point distinguishing the tool or the workpiece.

The error-compensated value or measured value can be, for example, a value for the highest point of the tool or workpiece or also a rotational position for the highest point of the tool or workpiece.

In particular, the error-compensated (measured) value can be determined using measured values which meet a specifiable criterion with respect to the mean value, in particular the arithmetic mean.

The measuring device for measuring tools or workpieces provides a measurement error compensation unit, which is configured to carry out the method for compensating for measurement errors when measuring tools or workpieces (or its refinements).

The measuring device can additionally also provide a measuring unit, in particular an optical measuring unit, particularly preferably a telecentric measuring unit.

The mounting device, in particular shrink device, for automated chucking and unchucking of a tool in a toolholder provides the measuring device for measuring tools or workpieces (or their refinements)—and/or—during a measurement of the tool in a process carried out in the mounting device, the method for compensating for measurement errors when measuring tools or workpieces (or its refinements) is carried out.

The device can also comprise self-calibrating mechanisms, which automatically check and adjust a calibration at regular intervals. They can calibrate the measuring unit automatically in that they use known standard measures to identify deviations and adjust the systems accordingly. This could be achieved by integrated calibration standards or reference tools which are measured periodically to check the calibration and perform adjustments as needed.

The device can also be equipped with an energy-efficient operating mode or other energy-efficient technologies, which offers both ecological and economic advantages. This could be achieved by the use of energy-saving modes or by the optimization of the energy consumption during the measurements.

In addition, the device can be equipped with a user-friendly interface and interactive feedback mechanisms as well as real-time feedback loops for continuous adjustment of the measurement parameters. This can be achieved by visual feedback, simple menu structures, and assistive functions. An intuitive user interface having visual dashboards, real-time feedback, and simple configuration options can help the operators to access measurement data quickly, prepare reports, and perform adjustments, by which the efficiency of the system is maximized.

The device can also be constructed in modular fashion in order to be able to be adapted easily to different tool types and sizes or workpiece sizes. This increases the flexibility and applicability of the device in various industrial contexts. A system for continuous tracking and reporting of the measurement data can also be implemented. This could comprise the preparation of reports for quality control purposes and ensure that all measurements are documented and checkable if needed, which is advantageous in particular in regulated industries.

Cloud-based data analysis and storage can also be used in the device for continuous improvement of the measurement process. These data can also be used for continuous improvement of the measurement process and for assistance in the error compensation.

The device can furthermore be networked with a central data analysis and management system, which contributes to optimizing the overall production process. Data can be collected, analyzed, and used to recognize patterns and increase efficiency. By using big data analysis tools, large amounts of measurement data can be analyzed to recognize trends which indicate possible future problems or improvement options. These analyses could then be used to plan proactive maintenance measures or optimize manufacturing processes.

The method can be carried out using environmentally-compensating methods, which minimize the influencing factors of temperature and humidity variations. This is particularly important in production environments which are not completely climate controlled.

The device can be integrated—seamlessly—in existing CNC machines or other manufacturing systems. This would reduce the need for manual transfers and increase the efficiency of the overall process chain in that the measurement and adjustment of the tools is integrated directly into the manufacturing process.

The invention is based on the finding—which has also in particular been experimentally confirmed—that known measuring devices, in particular telecentric measuring devices, supply incorrect measured values (systematically incorrect measured values)—under specific measurement conditions—when measuring tools and/or workpieces. Studies have also shown here that these errors—again under precisely these specific measurement conditions—are reproducible. The invention has therefore arrived at the finding that these errors are systematic errors—and not random errors.

On the basis of this finding, the invention has developed or can develop a systematic procedure which starts precisely at these systematic errors, compensates for them by way of the procedure according to the invention—and thus—in each case of a—initially incorrect—measurement ensures that the compensated measurement—“purified” of the systematic error—accordingly ensures ultrahigh precision without errors.

The invention is furthermore distinguished in that it is universally usable (in measurement systems and automated processes/facilities (in measurements therein)). It is simple, transparent, and thus ensures a high level of process accuracy and process reliability, for example, used in automated processes, for example, in a mounting device or shrink device for automated chucking and unchucking/shrinking and unshrinking of a tool in a toolholder.

It can preferably be provided in one refinement that a range having the most successive measured values which meet a specifiable criterion with respect to the mean value, in particular the arithmetic mean, in particular which are less than the determined mean value or the arithmetic mean, is determined in the measured value course.

The (measured) value which lies at a specifiable position, in particular in the middle, of the determined range can then be used as the error-compensated (measured) value for the point distinguishing the tool or the workpiece (first error-compensated measured value).

Furthermore, it can then also be provided here that for the measured value which lies in the middle of the determined range, or for the first error-compensated measured value, its associated rotational position (during the measurement) is determined.

This procedure in the first error-compensated measured value is then suitable in particular if accurately measured rotational positions are to be determined, for example, in processes on the tool having defined rotational position or alignment of the tool, in which these then in particular have to be held, moved, placed, and/or processed in another manner. If, for example, the rotational position of the first error-compensated measured value is determined, the tool or workpiece can then be rotated into this position—and held and processed or placed/moved there.

It can preferably be provided in another or alternative refinement that, from those measured values which meet a specifiable criterion with respect to the mean value, in particular the arithmetic mean, in particular lie within a specifiable value range around the mean value, in particular around the arithmetic mean, a further mean value, in particular a further arithmetic mean value, is determined as the error-compensated measured value for the point distinguishing the tool or the workpiece (second error-compensated measured value).

This procedure in the second error-compensated measured value is suitable in particular if high (accuracy) requirements are to be placed on measurements or measured values, for example, in validations (of geometry dimensions of the tool or workpiece).

Furthermore, it can also be provided here that the value range is located asymmetrically around the mean value or the arithmetic mean. For example, a first larger partial area can lie below the mean value or arithmetic mean, and a second smaller partial area above it. The size of the value range may be defined in particular depending on permitted/required tolerances.

It is expedient if the specifiable rotational angle by which the tool or workpiece—during the measurement—is rotated around its longitudinal axis from a defined starting rotational position is selected from a range between 5° and 300° or between 45° and 270°, in particular from a range between 75° and 180°, particularly preferably as 90°. The lower and upper limits mentioned can also be combined with one another differently, thus, for example, between 5° and 180° or 45° and 90°.

Furthermore, it can also be provided in particular that the measurement is carried out using a telecentric measurement method. Expressed alternatively—it can be provided that the measuring device is a telecentric measuring device. A combination of optical, acoustic, and tactile sensors (multiple sensors, sensor fusion) can also be used here to improve the measurement accuracy. The use of various sensor technologies—optical, acoustic, and tactile sensors—offers more comprehensive detection of the measured objects. Optical sensors could analyze the surface quality, for example, while acoustic sensors measure vibrations which could indicate structural anomalies. Tactile sensors could detect the physical shape and size more accurately. Laser interferometers for high-precision measurement of tool positions and tool movements can be integrated to enable an improved resolution and accuracy in the detection of tool geometries and tool movements. Thermal sensors can be used to detect the temperature of the tools and the surroundings, the data of which can be used to compensate for temperature-related measurement errors in order to ensure the accuracy under various ambient conditions.

Intelligent control systems can also be used, which are capable of independently making decisions and taking measures for error correction based on real-time data and preceding analyses. This is also true for coordinate measurement machines for carrying out in-process measurements. These machines can supply precise and detailed geometry information, which can be used to improve the tool measurement and tool calibration.

It can also be expedient for measured values and/or a measured value course to be smoothed, filtered, and/or processed by another statistical method, including the use of augmented error recognition (and/or compensation) for identifying systematic and random errors. These can also be based on historic data and measurement analyses. The use of statistical methods increases the reliability of the measurement results and minimizes the probability that erroneous data will be incorporated into the production process.

Adaptive algorithms can also help to continuously adjust parameters on the basis of real-time data. This makes it possible to react to changes in the surroundings or in the tool, such as tool wear, or in the material itself and thus to provide consistently precise results. AI algorithms can be used to recognize patterns in the measurement data and optimize the measurement methods accordingly. For example, neural networks can be used to identify frequent sources of error and perform automatic corrections. Adaptive algorithms could dynamically adjust the measurement parameters based on material changes or tool wear.

In a refinement, it can be provided that the method (or its refinements) is used in an automated process in machining a tool or workpiece, in particular a machining process of a tool in a mounting device, in particular a shrink device, for automated chucking and unchucking of a tool in a toolholder.

It can also be used in other automated processes, such as workpiece machining on machine tools. It can also be expedient in particular in presetting devices and/or balancing devices to use the method (or its refinements).

It appears expedient if the tool or workpiece—in a further process step of the automatic process—is rotated into the associated rotational position (with the measured value lying in the middle of the determined range or with the first error-compensated measured value) or is held in the associated rotational position—and in particular processed, for example, mounted, in particular shrunk/unshrunk, while thus held.

In the case of a mounting process, in particular shrinking process, and/or in the mounting device, in particular shrink device, the tool—held in this rotational position—can be chucked and/or unchucked or in particular shrunk.

The invention or the method (or its refinements) is in particular also suitable to be used during, in particular automated, mounting or presetting of the tool or during balancing of the tool or a complete tool made up of a toolholder and a tool held in this toolholder—in particular during measurements on the tool or complete tool therein.

It is also expedient in particular if the invention or the method (or its refinements) is used in measuring a milling tool, in particular a milling tool having one or more end blades. Experiments have thus shown that in particular when measuring milling tools, systematic measurement errors that are described occur, which could have to do with light refraction/diffraction or an optical phenomenon on blades in such a milling tool. Therefore, reliable and high accuracy measurements are achieved in particular with milling tools here—using the invention.

Where reference is only made hereinafter to a shrink device, the invention can also be applied analogously to other (in particular automated) (mounting) cells (having measuring tasks therein) using mounting or chucking methods for tools other than shrinking, for example, for collet chucks, hydraulic chucks, power chucks, Weldon chucks, or cutterhead chucks.

In this case, instead of the shrink device, the corresponding other appliance/device (or possibly (multiple) other appliances/devices (in particular different clamping methods)) which effectuates the other clamping method with the tool takes its place. The other appliances/devices—effectuating other clamping methods—can also be implemented in the cell together with the shrink device or also without the shrink device.

In particular, other device parts which relate to the actual chucking or unchucking procedure of the tool can also be adapted accordingly.

If necessary, in other devices for collet chucks, hydraulic chucks, Weldon chucks, or cutterhead chucks, parts can also be screwed on or mounted in an automated manner therein by corresponding handling units/devices, for example, union nuts in collets, or screws can be tightened, for example, compression screws in hydraulic chucks or clamping screws in Weldon chucks. The corresponding screwing units can be permanently installed on the device, for example, and the chucks can be guided to the screwing unit in particular with the aid of the first handling device. Vice versa, it is possible to also move the screwing unit with in particular the first handling device and to the chuck. In the latter case, the screwing unit can be permanently installed on a handling device or gripped thereby.

The description provided up to this point of advantageous designs of the invention contains numerous features which are reflected in the individual dependent claims, partially several of them in combination. However, these features can also expediently be individually considered and combined to form reasonable further combinations.

Although some terms were each used in the singular or in conjunction with a numeral in the description or in the claims, the scope of the invention is not to be restricted to the singular or the respective numeral for these terms. Furthermore, the words “a” or “an” are not to be understood as numerals, but rather as indefinite articles.

The above-described properties, features, and advantages of the invention and the manner in which they are achieved will become clearer and more comprehensible in conjunction with the following description of the exemplary embodiments of the invention, which are explained in more detail in conjunction with the drawings/figures (identical parts/components and functions have identical reference signs in the drawings/figures).

The exemplary embodiments are used to explain the invention and do not restrict the invention to combinations of features indicated therein, also not with respect to functional features. In addition, features of each exemplary embodiment suitable for this purpose can also explicitly be considered in isolated form, removed from an exemplary embodiment, introduced into another exemplary embodiment to supplement it, and combined with any of the claims.

Other features which are considered as characteristic for the invention are set forth in the appended claims.

Although the invention is illustrated and described herein as embodied in a method for compensating for measurement errors when measuring tools or workpieces, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is an illustration of a shrink device for automated shrinking and unshrinking of a tool in a toolholder according to one embodiment in a first view;

FIG. 2 is an illustration of the shrink device for automated shrinking and unshrinking of a tool in a toolholder according to the embodiment in a second view;

FIG. 3 is an illustration of the shrink device for automated shrinking and unshrinking of a tool in a toolholder according to the embodiment in a third view;

FIG. 4 is an illustration of the shrink device for automated shrinking and unshrinking of a tool in a toolholder according to the embodiment in a fourth view;

FIG. 5 is a perspective view of the shrink device for automated shrinking and unshrinking of a tool in a toolholder according to the embodiment in a fifth view;

FIG. 6 is an illustration of the conveyor box for the transport of toolholder and tools according to the embodiment in a first view;

FIG. 7 is an illustration of the conveyor box for the transport of toolholder and tools according to the embodiment in a second view;

FIG. 8 is an illustration of a conveyor box for the transport of toolholder and tools according to an embodiment in a third view;

FIG. 9 is a perspective view of the conveyor box for the transport of toolholder and tools according to the embodiment in a fourth view;

FIG. 10 is an illustration of a detail of the shrink device for automated shrinking and unshrinking of a tool in a toolholder according to an embodiment during a check of a toolholder (with or without tool);

FIG. 11 is an illustration of a detail of the shrink device for automated shrinking and unshrinking of a tool in a toolholder according to an embodiment during a check of a toolholder (with or without tool);

FIG. 12 is an illustration of a detail of the shrink device for automated shrinking and unshrinking of a tool in a toolholder according to an embodiment during a check of a tool (which is to be shrunk);

FIG. 13 is an illustration of a detail of the shrink device for automated shrinking and unshrinking of a tool in a toolholder according to an embodiment during a check of a tool (which is to be shrunk);

FIG. 14 is an illustration of a detail of the shrink device for automated shrinking and unshrinking of a tool in a toolholder according to an embodiment during a check during shrinking or unshrinking;

FIG. 15 is a perspective view of an induction coil assembly having replaceable stop washer in the shrink device for automated shrinking and unshrinking according to one embodiment (in perspective);

FIG. 16 is an illustration of an induction coil assembly having replaceable stop washer in the shrink device for automated shrinking and unshrinking according to one embodiment (from above);

FIG. 17 is a perspective view of an induction coil assembly having replaceable stop washer in the shrink device for automated shrinking and unshrinking according to one embodiment (from the front);

FIG. 18 is an illustration of an induction coil assembly having replaceable stop washer in the shrink device for automated shrinking and unshrinking according to one embodiment (from the rear);

FIG. 19 is an illustration of an induction coil assembly having replaceable stop washer in the shrink device for automated shrinking and unshrinking according to one embodiment (in section);

FIG. 20 is an illustration of a shrink device for automated shrinking and unshrinking of a tool in a toolholder having an ultrasonic cleaning system (for tools and/or toolholder) according to one embodiment in a view;

FIG. 21 is a graph showing a first measured value course in a measurement of a milling tool, in which a measurement error compensation according to the embodiment is illustrated; and

FIG. 22 is a graph showing a second measured value course in a measurement of a milling tool, in which a measurement error compensation according to the embodiment is illustrated.

### DETAILED DESCRIPTION OF THE INVENTION

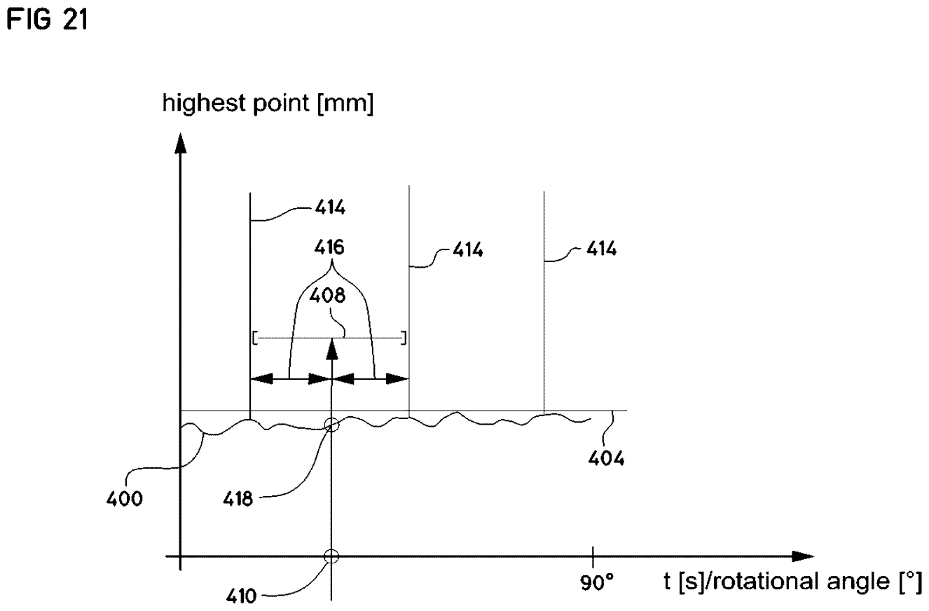

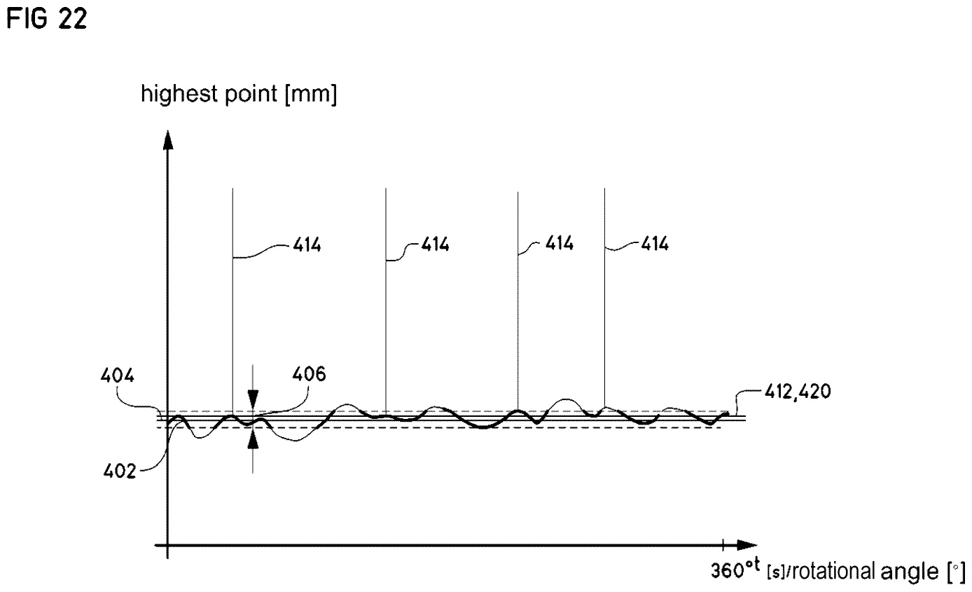

Measurement error compensation (for the measurement of tools or complete tools) (FIGS. 21 and 22)

### Correction Method 1

FIG. 21 shows a first measured value course 400 in a measurement of a milling tool 4 or its highest point by means of an optical measurement system, wherein the milling tool 4 was rotated around its longitudinal axis—and measured at the same time—during this measurement from a defined starting rotational position by a specifiable rotational angle, namely 90° here (abscissa/x coordinate: measurement time t (or rotational angle/position of the milling tool); ordinate/y coordinate: measured value for the highest point of the milling tool).

As can be seen from the first measured value course 400 of FIG. 21—on the basis of the “outlier” 414 in the measured value course 400—this is subject to error, it is to be suspected that the “outliers” 414 are incorrect measurements. Other minor variations in the measured value course could be metrologically caused—and do not represent measurement errors in the actual sense.

To now determine a measured value for the highest point of the milling tool, which reflects the true value, i.e. the actual height of the milling tool most accurately, the following procedure (implemented as a mathematical method in the measurement system) is provided (correction method 1).

As shown in FIG. 21, initially an arithmetic mean 404 (shown in FIG. 21) is determined in the measured values of the measured first measured value course 400.

Furthermore—in the first measured value course 400—the range 408 is then determined having the most successive measured values which are less than the determined arithmetic mean 404 (likewise shown in FIG. 21).

Furthermore, the measured value lying in the middle 416 of the determined range is then determined (also shown in FIG. 21).

This measured value lying in the middle is then taken as the error-compensated measured value (first error-compensated measured value 418) for the highest point of the milling tool 4—and assumed to be the actual value of the highest point.

Furthermore—as indicated in FIG. 21—the rotational position 410 of the milling tool 4 associated with the measured value lying in the middle or first error-compensated measured value 418 is then determined here.

### Correction Method 2

FIG. 22 shows a second measured value course 402 in a measurement of a milling tool 4 or its highest point by means of an optical measurement system, wherein the milling tool 4 was rotated around its longitudinal axis—and measured at the same time—during this second measurement from a defined starting rotational position by a specifiable rotational angle, namely now 360° here (abscissa/x coordinate: measurement time t (or rotational angle/position of the milling tool); ordinate/y coordinate: measured value for the highest point of the milling tool)).

As can be seen again from the second measured value course 402 of FIG. 22—on the basis of the “outlier” 414 in the second measured value course 402—this is also subject to error, it is to be assumed that the “outliers” 414 are incorrect measurements.

To now determine a measured value for the highest point of the milling tool 4, which reflects the true value, i.e. the actual height of the milling tool most accurately, the following procedure (implemented as a mathematical method in the measurement system) is provided (correction method 2):

As FIG. 22 illustrates, initially the arithmetic mean 404 (shown in FIG. 22) is again determined in the measured values of the measured second measured value course 402.

Furthermore—in the course 402—for those measured values which lie within a specifiable value range 406 around the arithmetic mean 404, namely 0.003 mm greater or 0.004 mm less (marked in FIG. 22), a further arithmetic mean 412 is determined (shown in FIG. 22).

This further arithmetic mean 412 is then taken as the error-compensated measured value (second error-compensated measured value 420) for the highest point of the milling tool—and assumed to be the actual value of the highest point.

The above-described two methods for compensating or correcting measurement errors, namely the correction method 1 and the correction method 2, are intended for the automated shrink cell 2 or shrink device 2 described hereinafter for automated shrinking and unshrinking of a tool in a toolholder - or measuring devices or measurements of tools therein (implemented in the respective measurement systems).

As described hereinafter, the shrink cell 2 provides various measurements of the tool 4 or complete tool made up of toolholder 6 and tool 4 held therein, namely by the measurement devices/systems 58, 94 (here measuring of the tool before the shrinking or during the shrinking) and the measurement device 60 (here measurement of the tool or complete tool after the cooling).

In this case, the correction method 1 is implemented in the measurement devices/systems 58 and 94, since measurements therein and correction method 1 (implemented therein) are intended in particular to determine a rotational position of the tool with reliable measurement, in which rotational position the tool can then be measured with higher reliability and accuracy. I.e. the rotational position determined here by the correction method 1 ensures that—measured (again) in this position—no “outliers” occur or (in other words) precludes incorrect measurements from occurring there if the tool is measured in this position.

The tool 4 is then rotated after the measurement and correction method 1 into the determined rotational position—and gripped in this position by a handling system 12/gripper system and—thus held—offset further.

The correction method 2 is implemented in the measurement device 60, since measurement therein and correction method 2 (implemented therein) are intended in particular to determine measured values, such as the highest point of the tool, with ultrahigh reliability and accuracy.

If the highest points on the tool 4 are measured using the mentioned measurement systems 58, 60, and 94, the measurement systems 58, 60, and 94 carry out “their” correction methods 1 and 2—and thus correct the measured values for the highest tool points.

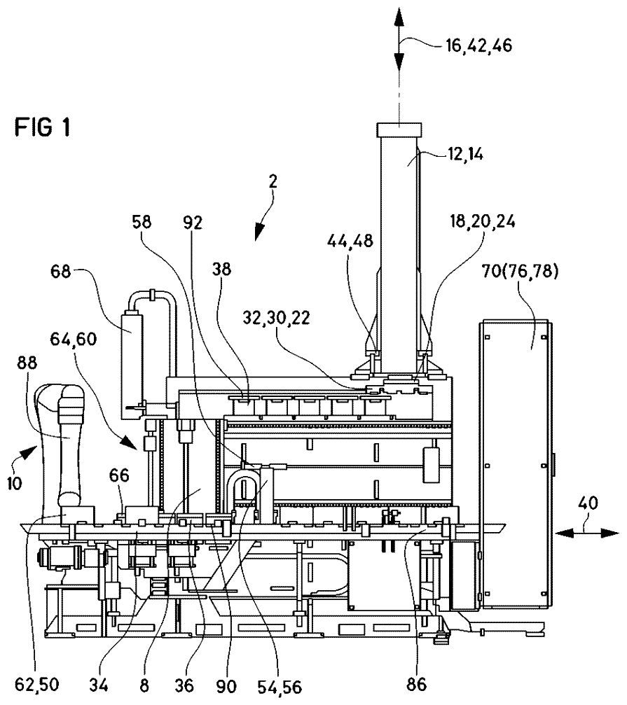

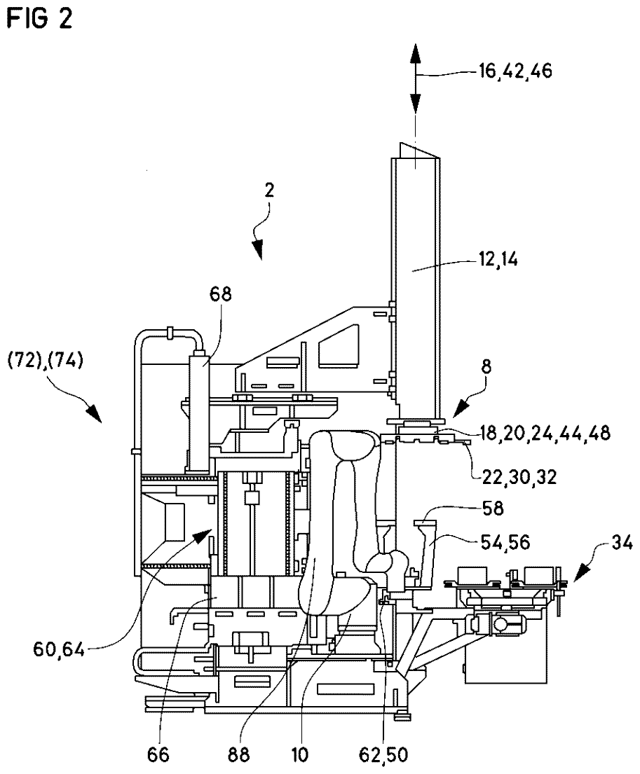

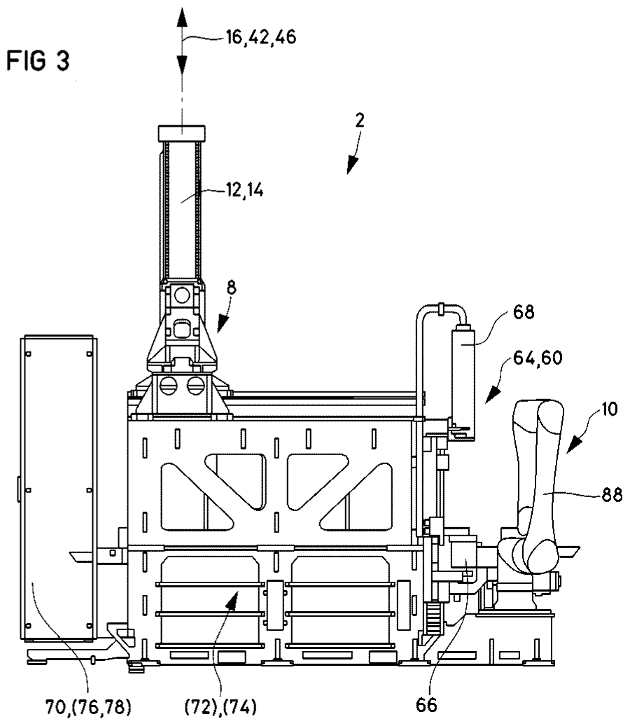

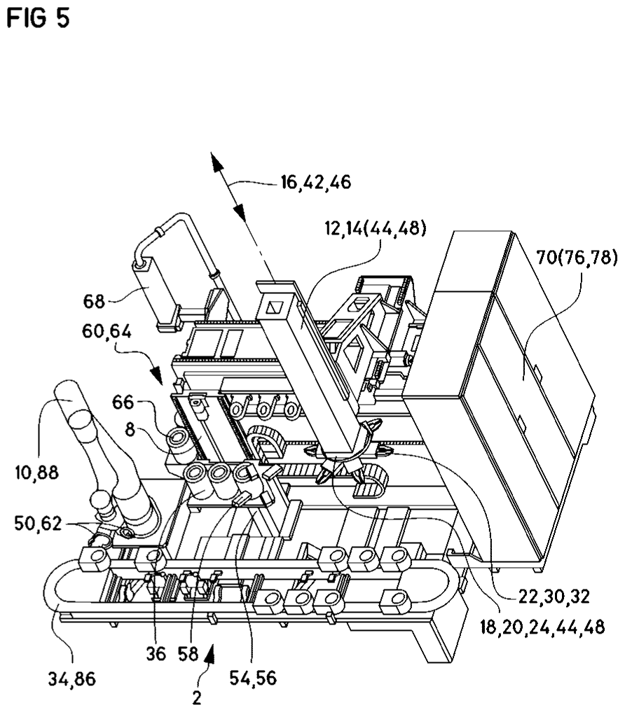

Automated shrink cell 2 or shrink device 2 for automated shrinking and unshrinking of a tool in a toolholder (FIGS. 1 to 5 and FIGS. 10 to 14)

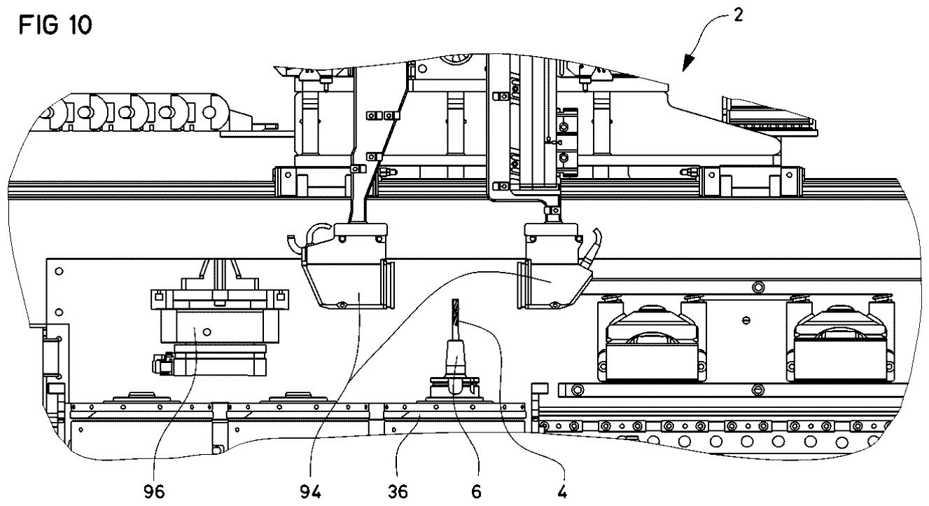

FIGS. 1 to 5 show—in various views and details—a shrink device 2 for automated shrinking and unshrinking of a tool 4 in a toolholder 6—referred to in short as an automated shrink cell 2 or only as a shrink cell 2. FIGS. 10 to 14 show—in details—checks of the tool 4 or the toolholder 6 in the shrink device 2.

### The System/the Shrink Cell 2

As FIGS. 1 to 5 show, the—compactly constructed—shrink cell 2 provides as essential components a conveyor belt 34, a multiaxis industrial robot/gripper arm 10, a centering station 54, an (inductive) shrink device 8, a cooling station 64 as well as switch cabinets 70 and a control computer 76 and also a safety shield 80—which are arranged in a compact structure in the form shown (in FIGS. 1 to 5)—and functionally interact in an integrative overall process of equipping a toolholder 6 with tools 4 (in the context of automated industrial manufacturing).

### Conveyor Device 34

Functionally, the “component part or component opening” the system or the shrink cell 2 is a conveyor device 34, which, as can be seen in FIGS. 1 to 5, is designed as a circulating, segmented conveyor belt 34.

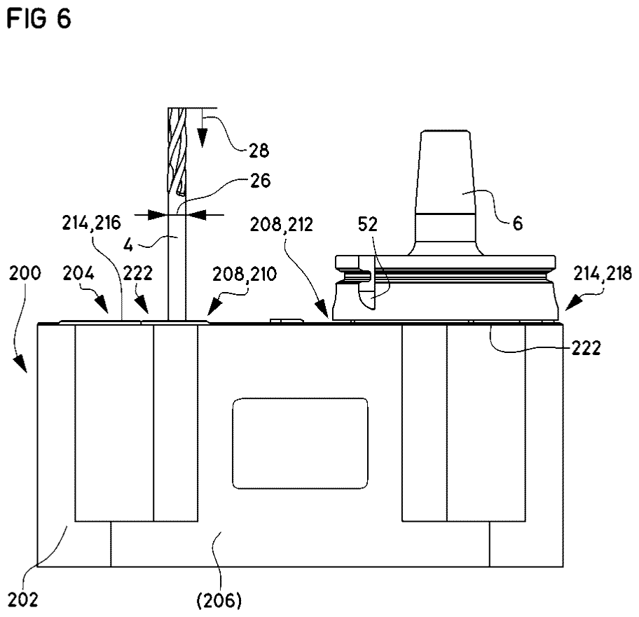

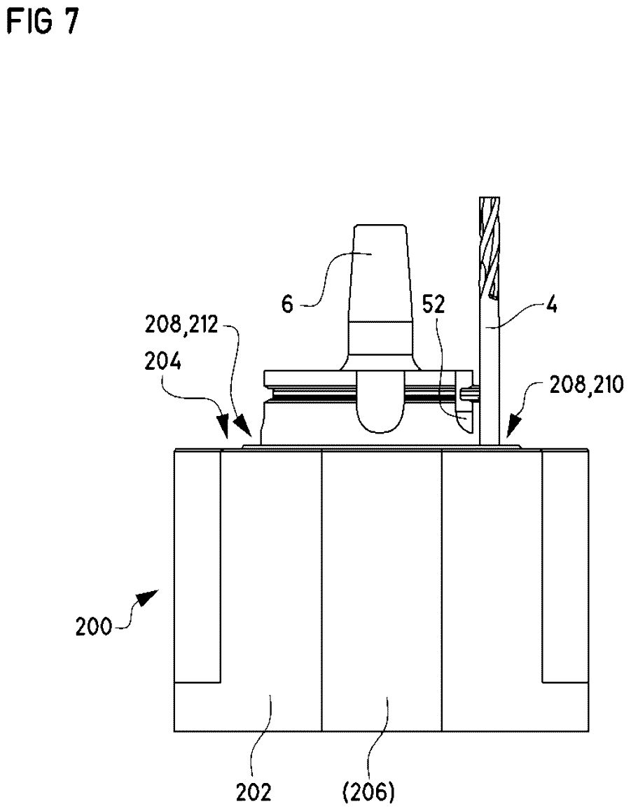

The individual segments 86 of the conveyor belt 34 are in turn designed here such that they can each be equipped with a conveyor box 200 (which in turn can again be equipped with tools 4 and toolholder 6) (see hereinafter on FIGS. 6 to 9).

### Multiaxis Industrial Robot/Gripper Arm 10

Furthermore, as can be seen from FIGS. 1 to 5, the shrink cell 2 provides a multiaxis articulated arm robot 10 (first multiaxis handling device 10), which is positioned laterally to the conveyor belt 34.

The articulated/gripper arm 88 of this multiaxis articulated arm robot 10 is designed having a double gripper 62—for gripping a tool 4 (first gripper), on the one hand, and for gripping a toolholder 6 (second gripper), on the other hand.

The position (see FIGS. 1 to 5) of the multiaxis articulated arm robot 10 and its arm geometry is provided such that the essential areas of the shrink cell 2 are reachable by the multiaxis articulated arm robot 10 or its double gripper 62.

### (Inductive) Shrink Device 8 Having Gripper Tower 12

The shrink device 8, which (geometrically, and also functionally) forms a central component part of the shrink cell 2, has, as shown in FIGS. 1 to 5, various (clamping) spindles 36 arranged adjacent to one another, only spindles 36 in short, by means of which tool holders 6 can be held clamped in position during the shrinking. The spindles 36 are also rotatable here around a vertical axis—referred to hereinafter as the Z axis 16.

The spindles 36 are in turn arranged on a horizontally 40 and vertically 42 (Z axis 16) movable positioning table 90, by which they can be moved or raised in the directions mentioned.

In the first handling device 10, furthermore a read unit 50, in this case an optical read unit 50, is arranged in the area of the double gripper 62, by means of which markings 52 (cf. FIGS. 6, 7, and 9), such as toolholder codes 52 in particular, which can be attached to a toolholder 6, can be read—in particular if a toolholder 8 chucked in one of the spindles 36 is rotated by means of the spindle 36 clamping it.

Furthermore, the shrink device 8 provides multiple induction coil assemblies 38, likewise arranged adjacent to one another, which are arranged at a specified vertical 42 distance (Z axes 16—distance) above the spindles 36—and which are also aligned with respect to the mentioned Z axis 16. The induction coil assemblies 38 also comprise—insofar as it is important here—the typical stop washers 92 (concentrators/ferrite washers).

If the induction coil assemblies 38 are also arranged at a fixed height, as shown here, it can also be provided that they are arranged to be vertically displaceable—along the Z axis 16.

The mobility of the positioning table 90 carrying the spindles 36 is designed such that—on the one hand, each of the spindles 36 is movable in extension of the Z axis 16 below each induction coil assembly 38—and, on the other hand, each spindle 36 can be raised along the Z axis 16 up to each induction coil assembly 38.

Furthermore, means 44, 48 are also provided here, by means of which the vertical 42 raising travel 46 of the spindles 36 and a collision with the induction coil assemblies 38, in particular with the stop washers 92 of the induction coil assembly 38, can be monitored.

In addition, in the shrink device 2, the mentioned multiple spindles 36 and induction coil assemblies 38 are installed—in this case shown three spindles 36 and five induction coil assemblies 38, this large number of spindles 36 and induction coil assemblies 38 have different geometric dimensions in order to thus also be able to shrink a complete range of tools 4 and toolholders 8.

Furthermore, as can be seen in FIGS. 1 to 5, the shrink device 2 provides a handling device 12 (second, automatically movable handling device 12)—only referred to in short hereinafter as the gripping tower 12—which is automatically movable—by means of a linear drive 14 along the Z axis 16.

The gripper tower 12—notwithstanding its linear mobility along the Z axis 16 and independently thereof—is also itself automatically movable horizontally 40—to a specifiable extent.

The gripper tower 12 provides, as FIGS. 1 to 5 show, a gripper head 18 rotatable around the Z axis 16. The rotational position of the gripper head 18 can be determined by means of an angle measuring device 20 and therefore its positioning can be monitored.

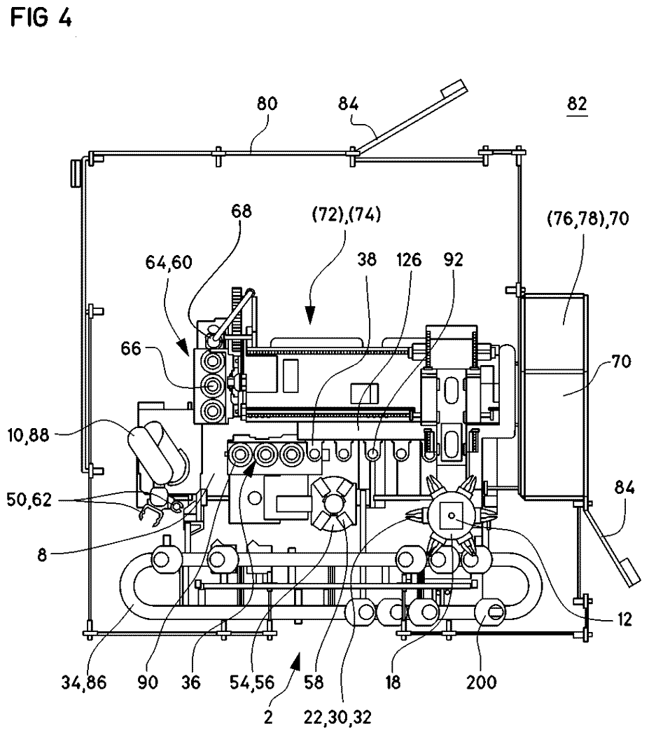

The gripper head 18 in turn comprises multiple gripper devices 22 (clamping grippers 22) for gripping tools 4. As can be seen from FIG. 4 in particular, the multiple gripper devices 22, in this case six, are arranged evenly distributed around the Z axis 16 on the gripper head 18.

In addition, the gripper head 18 is equipped with force measuring units 24, using which a traction and/or thrust force of the gripper head 18 or the gripper device 22 on a tool 4 is measurable in order to thus be able to monitor an insertion of a tool 4 into a toolholder 6 or a withdrawal of a tool 4 out of a toolholder 6 (the gripper tower 12 or the gripper head 18 travels here along the Z axis 16).

Furthermore, such a (or each) gripper device 22 is equipped with two gripper jaws 30 movable relative to one another during the gripping procedure and movable by electric motor. The electromotive adjustment of the gripper jaws 30 enables a gripping procedure to be measured and monitored, in particular with respect to a gripping force.

Each gripper jaw 30 provides a stop lug 32, which can be used as a contact element during positioning (along the Z axis 16). The gripper jaws 30 are in turn also arranged so they are replaceable—and can be clamped precisely in position in the gripper device 22.

To be able to grip an entire range of differently dimensioned tools 4, the gripper devices 22 are adapted to tools 4 of specifiable diameter 26.

Centering station 54 having alignment monitoring or alignment monitoring device 58 (measurement system 58)

As FIGS. 1 to 5 also show, the shrink cell 2 provides a centering station 54—arranged in the area between the conveyor device 34 and the shrink device 8—for clamping and directing (aligning) a tool 4.

The centering station 54—in this case shown here—comprises three symmetrically arranged clamping jaws 56, by means of which a tool 4 can be held centered (and) clamped.

In addition—above the clamping jaws 56—an alignment monitoring device 58, for example, in the form of an optical measurement system 58—is provided on the centering station 54, in which the correction method 1 is implemented, using which an alignment in particular in relation to the Z axis 16 of a tool 4 taken from the centering station 54 by means of the gripper tower 12 can be determined and monitored.

By means of this alignment monitoring device 58 or the measurement system 58, it is also to be possible to measure the geometry of a tool 4.

### Cooling Station 64

In the shrink cell 2, a cooling station 64 for cooling toolholders 6 heated by the shrinking is located laterally to the left adjacent to the shrinking device 8, as is essentially described in the laid-open application, namely non-prosecuted German patent application DE 10 2022 114 046.6.

The cooling station 64—as installed here according to FIGS. 1 to 5—comprises—similarly to the shrink device 8—multiple (clamping) spindles 66 arranged adjacent to one another, also only spindles 66 in short, in this case three spindles 66 here, using which toolholders 6 can be held clamped during cooling (and possibly rotated if needed).

In addition, the cooling station 64 provides a cooling attachment 68, which can be slipped over toolholders 6 held on the spindles 66 and which is configured to generate turbulence cooling (cyclone cooling).

Such a cooling attachment 68 is described, for example, in the cited laid-open application for the application having the official reference number DE 10 2022 114 046.6.

### Balancing Device 72 and Presetting Device 74

Furthermore, a balancing device 72 and possibly also a presetting device 74 (not shown) can also be arranged at the back of the shrink device 8.

The balancing device 72 and the presetting device 74 can be designed as usual for the sake of simplicity (known from the prior art).

In this way, it would be possible to balance and measure “freshly shrunk” toolholders 6 (also “immediately”). Measurement systems that can be provided there can then also be equipped with the error correction. I.e. the correction method 1 or 2 is implemented in these measurement systems and in the case of a measurement of the highest point corrects these values correspondingly.

### Switch Cabinets 70 and Control Computer 76

In the shrink cell 2, as FIGS. 1 to 5 show, switch cabinets 70 and a control computer 76 (having display screen, input means, and printer) (not visible) are located laterally to the right adjacent to the shrink device 8, in which the (control) electronic/electrical systems (insofar as not directly installed in the component parts/components) or the controller 78 (software 78) for the shrink cell 2 are accommodated or stored.

The shrink cell 2 can be operated or controlled via the control computer 76.

### Safety Screen 80/Safety Fence 80

To protect the shrink cell 2, it provides a safety shield 80—here in the form of a safety fence 80—by means of which large areas of the shrink cell 2 can be shielded (around) in relation to an environment 82 around the shrink cell 2.

As FIG. 4 shows in particular, this safety shield 80 or this safety fence 80 comprises two doors 84 (possibly automatically lockable/unlockable), through which areas at the shrink cell 2 can be accessed.

The safety shield 80 or the safety fence 80 also leaves a “middle” area of the conveyor belt 34 unshielded, so that it is possible here to equip the conveyor belt 34 (manually, and also in an automated manner), for example, with the conveyor boxes 200 (see hereinafter).

All components of the shrink cell 2 are connected to one another by means of a wiring system (not shown in more detail), so that data, such as control commands and also geometry data (of tools 4 and toolholders 6) can be transmitted therein or can be present there.

### The Process

The automated shrinking or unshrinking of tools 4 in toolholders 6 in the above-described shrink cell 2 runs according to the following process:
(a) equipping a conveyor box 200 arranged on the conveyor device 34 with a tool 4 (to be shrunk) and a toolholder 6 (in particular location-oriented) with a tool 4 (to be unshrunk),
(b) transporting the conveyor box 200 equipped with the tool 4 (to be shrunk) and the toolholder 6 having the tool 4 (to be unshrunk) by means of the conveyor device 34 to the shrink device 8 or therein to the vicinity of one of the (clamping) spindles 36 of the shrink device 8,
(c) placing the toolholder 6 having the tool 4 (to be unshrunk) (always only the toolholder 6 hereinafter for the sake of simplicity) from the conveyor box 200 onto the or one of the spindles 36 of the shrink device 8 using the multiaxis articulated arm robot 10,
(d) clamping the toolholder 6 on the spindle 36 of the shrink device 8,
(e) rotating the toolholder 6 clamped on the spindle 36 of the shrink device 8 around the Z axis 16 and reading a marking 52 or toolholder code 52 attached to the toolholder 6 by means of the read unit 50,
(f) providing toolholder, tool, and shrink data or parameters, in particular using the marking 52 or toolholder code 52 which is attached to the toolholder 6 and read,
(g) placing the tool 4 (to be shrunk) from the conveyor box 200 into the centering station 54 by means of the multiaxis articulated arm robot 10,
(h) clamping and aligning the tool 4 (to be shrunk) in the centering station 54,
(i) gripping the tool 4 (to be shrunk) clamped in the centering station 54 by means of the gripper tower 12 or gripper device 22 (clamping gripper 22) therein such that the tool 4 (to be shrunk) has a specifiable position in the toolholder 6 after the shrinking in the toolholder 6,
(j) measuring the tool 4 (to be shrunk) gripped by the gripper tower 12 by means of the measurement system 58 (cf. correction method 1) and measuring the alignment of the tool 4 (to be shrunk) with respect to the Z axis 16—and possibly also its geometry (for example, length or highest point),
(k) moving the toolholder 6 clamped on the spindle 36 of the shrink device 8—up into the extension of the Z axis 16 below the induction coil assembly 38 (intended for the current shrinking) of the shrink device 8,
(l) determining the raising travel 46 of the toolholder 6 clamped on the spindle 36 of the shrink device 8 along the Z axis 16—possibly also using the geometry of the toolholder 6,
(m) raising the toolholder 6 clamped on the spindle 36 of the shrink device 8 along the Z axis 16 until the toolholder 6 stops on the stop washer 92 of the induction coil assembly 38,
(n) (at the same time) monitoring the raising procedure 46 of the toolholder 6 clamped on the spindle 36 of the shrink device 8 with respect to the raising travel 46 (cf. lifting travel monitoring device 44) and a collision with the induction coil assembly 38 or with stop washers 92 of the induction coil assembly 38 (cf. collision monitoring device 48),

### Unshrinking the “Old/Used” Tool 4 From the Toolholder 6 and Shrinking a New Tool 4 in the Toolholder 6

(o) heating the toolholder 6 using the induction coil assembly 38 of the shrink device 8,
(p) gripping the tool 4 (to be unshrunk) arranged in the toolholder 6 by way of the gripper tower 12 or gripper device 22 (clamping gripper 22) and moving the tool 4 (to be unshrunk) gripped by the gripper tower 12 or its gripper device/clamping gripper 22 along the Z axis 16 out of the toolholder 6—with monitoring of the movement of the gripped tool 4 with respect to a traction force on the tool (to be unshrunk) (cf. force measuring device 24),
(q) pivoting or turning/rotating the gripper head of the gripper tower (cf. angle measuring device 20),
(r) moving (in particular location-oriented inserting) of the tool 4 (to be shrunk) gripped by the gripper tower 12 along the Z axis 16 relative to the toolholder 6 to a specifiable shrink position with respect to the toolholder 6 until the stop lugs 32 of the gripper device 22 of the gripper head 18 rest on the upper end face of the toolholder 6 (or on the stop washer 92 of the induction coil assembly 38), with monitoring of the movement of the gripped tool 4 with respect to a thrust force on the tool (to be shrunk) (cf. force measuring device 24),
(s) briefly holding the tool 4 (to be shrunk in the toolholder 6) by means of the gripper tower 12 at least until the tool 4 (to be shrunk) is clamped by cooling of the toolholder 6,
(t) lowering the toolholder 6 (which clamps the tool 4 just newly shrunk) clamped on the spindle 36 of the shrink device 8 along the Z axis 16,
(u) placing the toolholder 6 (which clamps the tool 4 just newly shrunk) clamped on the spindle 36 of the shrink device 8 using the multiaxis articulated arm robot 10 in the cooling station 64—and clamping the toolholder 6 therein on one of the spindles 66,
(v) cooling the toolholder 6 (which clamps the tool 4 just newly shrunk) using the turbulence cooling (cyclone cooling) of the cooling attachment 68,
(w) measuring the toolholder 6 (which clamps the tool 4 just newly shrunk) in the cooling station (cf. measuring device 60; the correction method 2 is implemented in this measuring device 60),
(x) moving the tool 4 (just unshrunk) by means of the gripper tower 12 to the conveyor box 200 and equipping the conveyor box 200 with it or moving the tool 4 (just unshrunk) by means of the gripper tower 12 to the centering station 54 (and possibly placing the tool 4 from there in the conveyor box 200),
(y) placing the (cooled) toolholder 6 in the conveyor box 200 by means of the multiaxis articulated arm robot 10,
(z) transporting the equipped conveyor box 200 away by means of the conveyor belt 34.

### Checks of the tool 4 or the toolholder 6 in the shrink device 2 (FIGS. 10 to 14)

For these checks, the shrink device 2, as FIGS. 10 to 14 show, provides a high accuracy measurement system 94, here a transmitted light measurement system 94, which is movable along the Z axis and also transversely thereto in the shrink device 2. The correction method 1 is implemented in this measurement system.

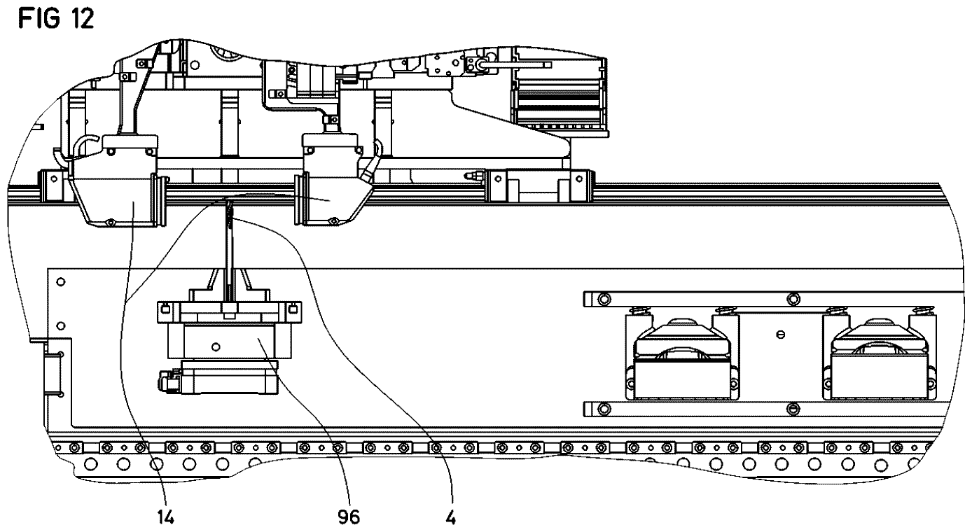

Furthermore, the shrink device, as FIGS. 12 to 13 show, comprises—in addition to the above-described spindles 36—a rotatable jaw chuck 96, which is (likewise) provided to clamp tools (here during their checking) (cf. FIGS. 12 and 13)—and which jaw chuck 96 is likewise movable transversely to the Z axis.

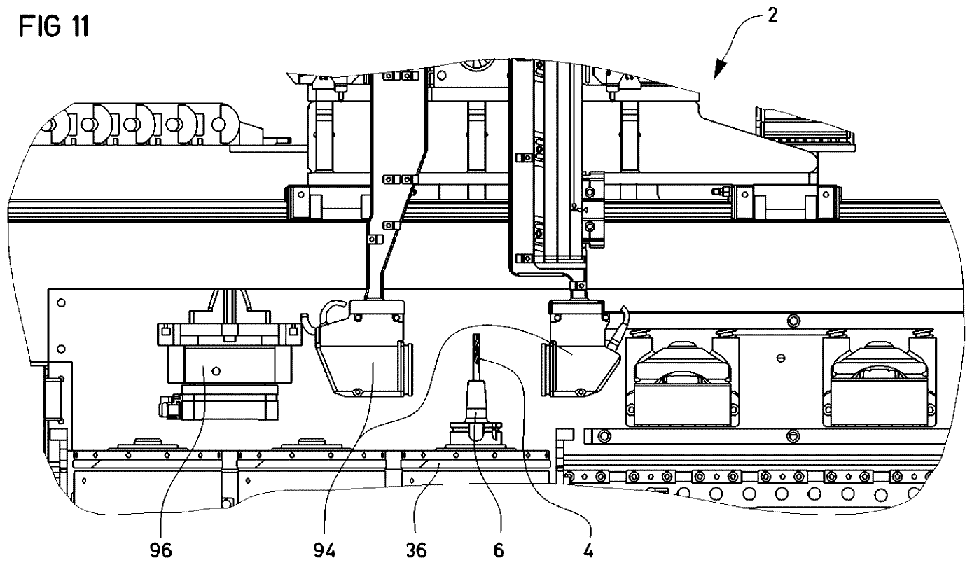

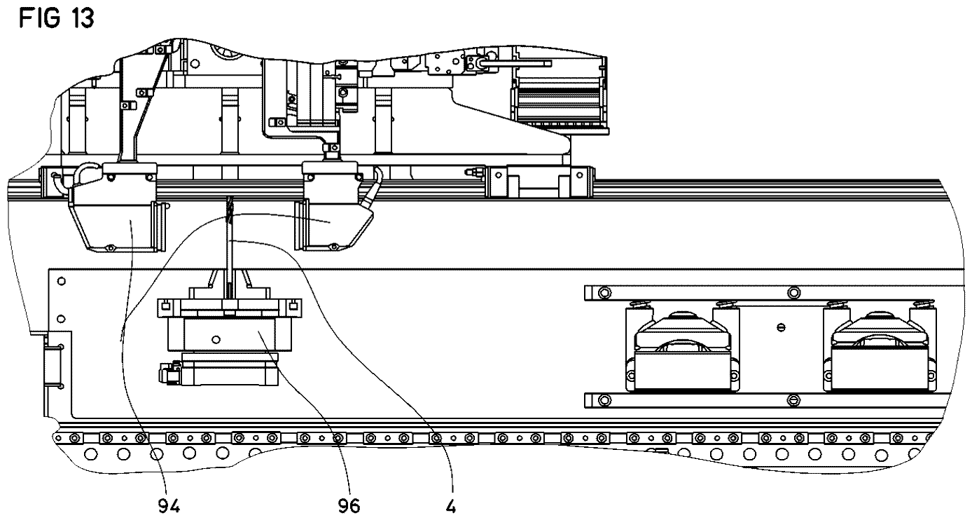

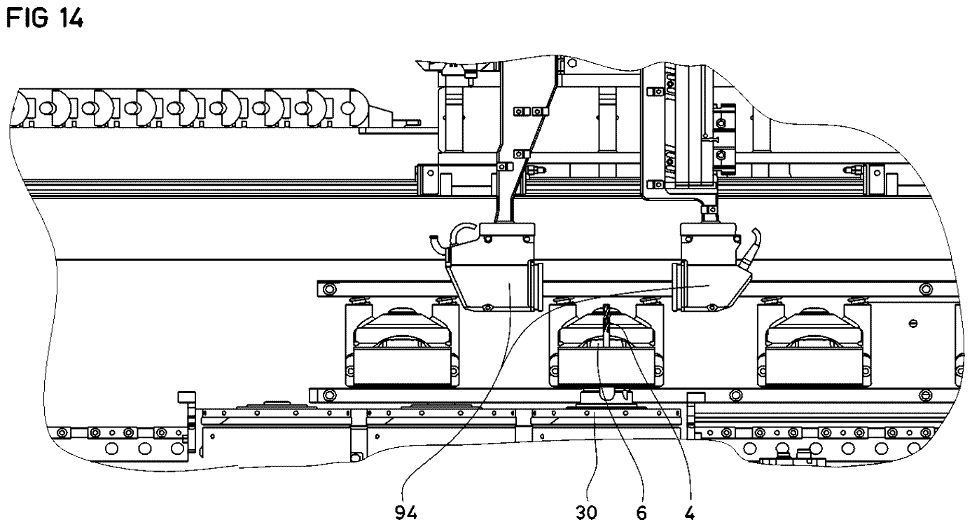

Three important checks/validations are carried out on the toolholder 6 or on the tool 4 by the measurement system 94:
(1) Checking and validating a tool holder 6 (with or without tools 4, in which the tool 4 is to be shrunk) (FIGS. 10 and 11),
(2) Checking and validating a tool 4 which is to be shrunk (FIGS. 12 and 13),
(3) Checking and (simultaneous) correction during shrinking and during unshrinking of the tool 4 (FIG. 14).

Due to the integration of the measurement system 94 (cf. correction method 1) in the shrink device and in the automated tool change in the shrink device 2, the process and sequence reliability and the accuracy in the tool change can be maximized.

### (1) Checking and Validating a Toolholder 6 (With or Without Tool 4) (FIGS. 10 and 11)

FIG. 10 shows a detail of the shrink device 2 during the check of a toolholder 6 (with or without tool 4—shown here with tool 4) (in a first (upper) measurement position).

In this case, according to FIG. 10, the measuring device 94 is located—above—positioned in relation to the toolholder 6 (with chucked tool 4 to be shrunk), which toolholder 6 is held in the spindle 36, such that at least the highest point of the tool 4 protrudes into the measurement area of the measurement system 94.

During the check, the measurement system 94 is now moved vertically downward along the Z axis (see FIG. 11—second (middle) measurement position), so that the measurement area of the measurement system 94 passes over the toolholder 6 (with tool 4) from top to bottom—and the toolholder 6 (with chucked tool 4) is measured (scanned) as a whole—and can subsequently be validated.

In this case, the toolholder 4 (with tool 4) is measured or checked, among other things, for:
total length (of toolholder with tool) in order or in tolerance,
blade diameter,
state of the blades,
cleanliness, (adhering) soiling, for example, chips,
coatings (paint) and/or surface states,
state of possibly multipart tools, for example, correct seat of reversible plates,
cutting and gripping area,
cylindricity of the gripping or shaft area (h6 tolerance),
toolholder—length A dimension in order,
insertion depth of the tool 4 in the toolholder 6 (in conjunction with information about the total length of the tool),
projection length,
shaft length,
in toolholders having screw clamping (Weldon, hydraulic, . . . ) determining the key width,
collisions (collision check, e.g., gripper, shrinking coil),
correct toolholder 6/correct tool 4, and
gripping area in order.

The toolholder 6 (with tool 4) can then be validated on the basis of the measurement.

If a toolholder 6—without chucked tool 4—is present during the check, this (i.e. the absence of the tool 4) can also be detected and/or recognized during the measurement.

### (2) Checking and Validating a Tool 4 (Which is to be Shrunk) (FIGS. 12 and 13)

FIG. 12 shows a detail of the shrink device 2 during the checking and validating of the tool 4 (which is to be shrunk) (in a first (upper) measurement position).

In this case, according to FIG. 12, the measuring device 94 is located - above - positioned in relation to the tool 4 such that at least the highest point of the tool 4 protrudes into the measurement area of the measurement system 94.

During the check, the measurement system 94 is now moved vertically downward along the Z axis (see FIG. 13—second (middle) measurement position), so that the measurement area of the measurement system 94 passes over the tool 4 from top to bottom—and thus the tool 4 is measured (scanned) as a whole (cf. correction method 1 (for the highest point))—and can subsequently be validated.

For this purpose, as also shown in FIGS. 12 and 13, the tool 4 can be clamped in a rotatable jaw chuck 96—and the measurement system 94 checks—according to FIG. 12—the uppermost point of the tool 4 (cf. correction method 1) in this case—and then—according to FIG. 13—the area where a gripper accepts the tool 4 for shrinking. The jaw chuck 96 is designed in an advantageous embodiment so that the part of the tool 4 chucked in the jaw chuck 96 can also still be detected and checked or measured by the measurement system 94.

The tool 4 is comprehensively checked and validated here by rotation of the jaw chuck 94.

Therefore, among other things, the following can be measured or checked:
tool length,
tool diameter,
tool shaft diameter,
cylindricity of the tool shaft (h6 tolerance),
presence of clamping surfaces on the tool shaft (for example, Weldon clamping surface),
state of the blades,
cleanliness, (adhering) soiling, for example, chips,
coatings (paint) and/or surface states,
state of possibly multipart tools, for example, correct seat of reversible plates,
cutting and gripping area,
shoulder milling,
collisions (collision check, for example, gripper), and
gripping area in order.

### (3) Checking and (Simultaneous) Correction During Shrinking and During Unshrinking of the Tool 4 (FIG. 14)

FIG. 14 shows a detail of the shrink device 2 during a check and (simultaneous) correction during shrinking and unshrinking of the tool 4 (in a measurement position).

In this case, according to FIG. 14, the measuring device 94 is positioned—above—the tool 4 such that at least the highest point of the tool 4 protrudes into the measurement area of the measurement system 94—and can thus be measured “live”.

The process is thus monitored during the shrinking and unshrinking by means of this measurement system 94.

During the shrinking, the length of the complete tool is corrected simultaneously, since the highest point can be corrected “live” using the controller of the shrink device 2.

During the unshrinking, it is monitored whether the tool 4 can be unshrunk from the toolholder 6—and if it is possible to prevent the gripper from slipping into collision areas here if problems occur during the unshrinking. For this purpose, it is compared whether the withdrawal movement of the gripper corresponds with the actual movement of the tool.

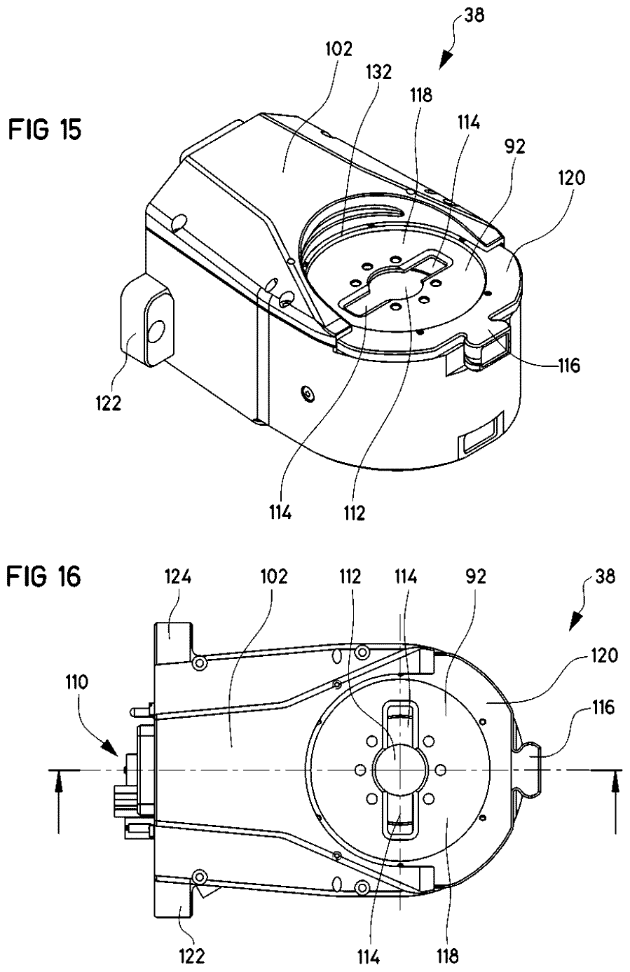

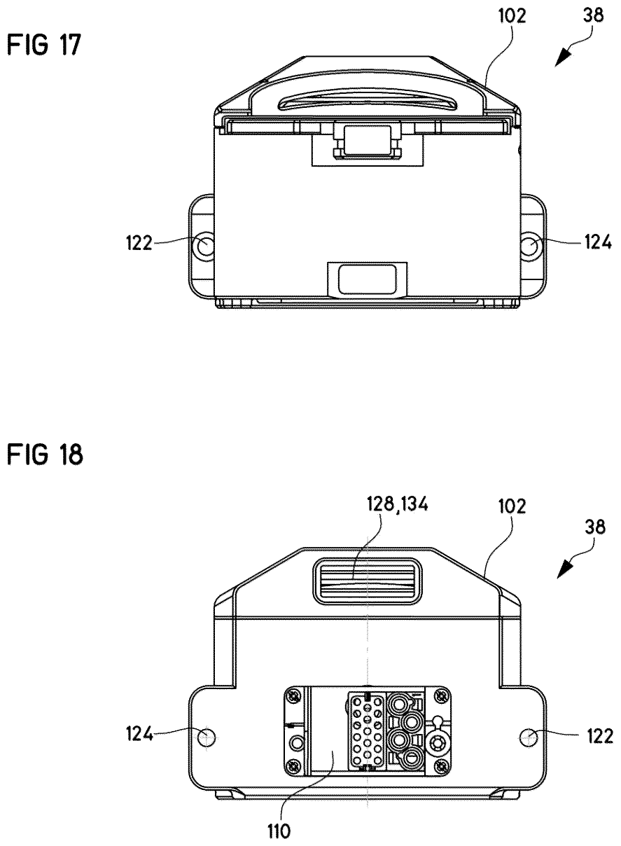

### Induction Coil Assembly 38 Having Replaceable Stop Washer 92 (FIGS. 15 to 19)

FIGS. 15 to 19 show—various views—of an induction coil assembly 38 present in the shrink cell 2.

As already mentioned, an entire range of tools 4 and toolholders 8 can be shrunk using the shrink device 2, which each differ in their geometrical dimensions, such as tool and toolholder diameter.

To enable this variability or flexibility, multiple, in this case five, induction coil assemblies 38 are installed in the shrink device 2, which each differ, among other things, in their winding bodies 104, in particular winding body heights and diameters, in order to thus be able to shrink (geometrically) different toolholders 8, which differ in particular in the length of the area to be heated.

Furthermore, this variability or flexibility is enabled in that the various induction coil assemblies 38 each have a replaceable or exchangeable stop washer 92, the design of which is adapted to various tools 4 or their tool diameters.

If the induction coil assemblies 38 and the stop washers 92 are each coded by means of a readable code in accordance with their determination for shrinking (see above on the variability or flexibility), the correct combination of induction coil assembly 38 and stop washer 92 (for this specific tool 4 or specific toolholder 8) can be selected for shrinking a specific tool 4 or toolholder 8 and “compiled”—and thus used in the process.

FIGS. 15 to 19 show—in various views—(by way of example) such an induction coil assembly 38—having replaceable stop washer 92.

As FIGS. 15 to 19 show, the induction coil assembly 38 provides a coil housing 102, in the interior of which the annularly wound winding body 104 is accommodated.

Various plugs/connections and connection elements 110 are attached to the rear end of the coil housing 102, which have plug connections—if the coil housing is screwed onto its carrier 126 (cf. FIG. 4) via the left and right screw connection 122, 124—with complementary plug connections/connection elements 110 there, by which the electrical parts/electronics of the induction coil assembly 38 can be supplied with power.

A further important component part of the induction coil assembly 38 is the stop washer 92 mentioned, which is insertable on its upper side into a groove 132 forming a guide there. Detent elements (not shown) in the groove 132 can lock the completely inserted stop washer 92.

The stop washer 92 consists of a disk-shaped washer element or ferrite body 118, which is accommodated in a frame 120 made of aluminium.

A circular passage opening 112 is located in the middle of the ferrite washer 118, the diameter of which is matched to tools 4 to be shrunk in the toolholder 8 or again the diameter thereof (—and is thus different for all ferrite washers—see above). Furthermore, recesses 114 are provided opposite to the circular passage opening 112 of the ferrite washer 118, which enable the clamping gripper 22 to insert the tool 4 to be shrunk gripped thereby through the passage opening 112 into the toolholder 8 or (during unshrinking) to grip the respective tool to be unshrunk accordingly and withdraw it from the toolholder 8.

A gripping element 116 is arranged at the front edge of the frame 120 of the stop washer 92, which is used so that the stop washer 92 can be gripped by one of the clamping grippers 22—during the replacement. I.e. at least one of the multiple gripper devices 22/clamping grippers 22 of the gripper head 18 is predetermined to carry out this gripping or the stop washer replacement.

The mentioned, nearly semicircular groove 132, which is open to the front, and into which the stop washer 92 can be inserted—from the front to the rear—is located on the upper side of the induction coil assembly 38. The stop washer 92 or its frame 120, which is nearly round as such, is flattened on both sides; accordingly, the groove 132 runs out in straight lines at its front ends on both sides, due to which the stop washer 92 can only be inserted in a defined manner or aligns itself into its correct position accordingly during the insertion.

By means of two mechanical contact switches 106, 108—one in front, one at the rear on the contact edge of the stop washer 92 or its frame 120 on the coil housing 102, the insertion of the stop washer 92 or its position is monitored. In particular, it is recognized by these contact switches 106, 108 whether the stop washer is correctly or completely positioned or inserted.

The winding body 104 in the coil housing 102 is cooled by compressed air cooling such that compressed air is blown into the coil housing in the area of the connection/plug elements 110 via the carrier 126.

For cooling the tool 4 or toolholder 8 (after the shrinking) accommodated in the induction coil assembly 38 or in the winding body 104, an annular duct 136 is provided in the winding body 104, which is connected via evenly distributed openings 138—six in this case—on the inside to the opening accommodating the tool 4 and the toolholder 8. The annular duct 136 is supplied with compressed air/cooling air from the outside via a pressure line (not shown) and a connection 140 opening into the annular duct 136. Via the annular duct 136 and the openings 138, the compressed air can then be blown onto the tool 4/toolholder 8.

Other cooling media (than compressed air) are usable accordingly in the induction coil assembly 38.

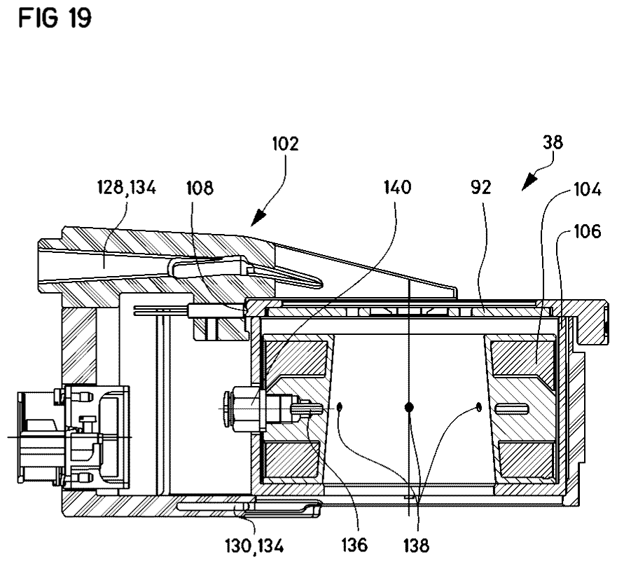

Vapors and/or gases arising during the shrinking are extracted via a fume extractor 134 in the induction coil assembly 38. For this purpose, as FIGS. 18 and 19 show, the coil housing 102 provides an (upper) fume extraction duct 128 in its upper area or a (lower) fume extraction duct 130 in its lower area, via which vapors/gases escaping upward or vapors/gases escaping downward can be extracted.

Stop washers 92 to be replaced are stocked in a replacement store (not shown) in the shrink cell 2.

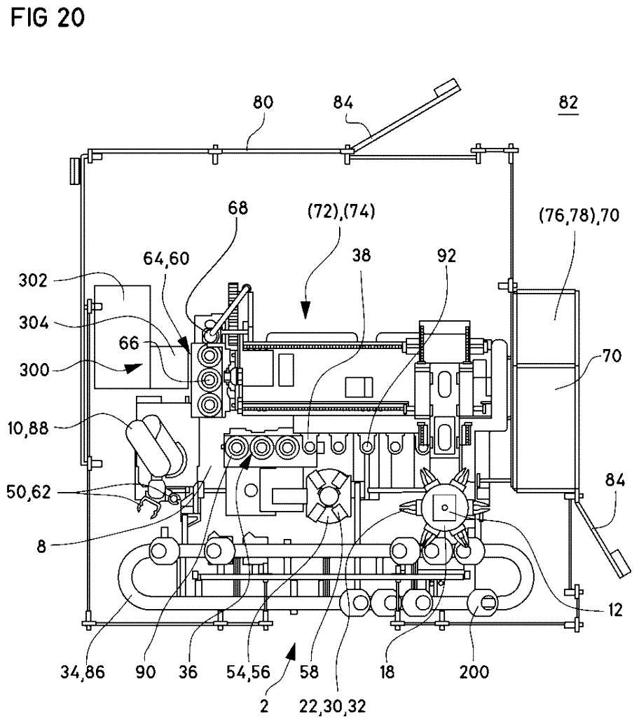

Automated shrink cell 2 or shrink device 2 for automated shrinking and unshrinking of a tool in a toolholder having an ultrasonic cleaning system 300 (FIG. 20)

FIG. 20 shows the automated shrink cell 2—described above. Structure and function/process were described above—reference is made to the statements above.

In addition, this shrink cell 2 according to FIG. 20 provides ultrasonic cleaning—implemented by an ultrasonic cleaning system 300—comprising an ultrasonic basin 302 and a drying system 304—here for the cleaning (and drying) of tools 4 before the shrinking.

Corresponding ultrasonic cleaning may also be used accordingly for the cleaning of toolholder/tool before the unshrinking.

For the automated process in the shrink cell 2 and in particular automated measuring of the tools 4 or toolholders 8 therein (see above, cf. in particular statements on the measurement system 94 or (2) checking and validating a tool 4 which is to be shrunk (FIGS. 12 and 13)), it is indispensable for the components, in particular the tool 4—for the measurement—to be clean, i.e. free of dirt, oil, dust, and the like. If soiled components were or are measured, the measurement results are corrupted, which then leads to a quality reduction in the context of the machining process during the production. Clean components and in particular clean tools 4 are indispensable for ensuring quality. Gripping areas on the tools 4 or toolholders 8 also have to be free of soiling.

As can be seen in FIG. 20, the ultrasonic cleaning system 300 provides an ultrasonic basin 302—for example, having the dimensions 1 m×0.6 m×1.2 m (length/width/height)—filled with water and a cleaning liquid.

To keep the cleaning liquid clean, in addition an oil separator having overflow function is provided in the ultrasonic basin 302. Sediment particles are removed from the bottom of the ultrasonic basin 302 or from the ultrasonic basin 302 by regular cleaning of the ultrasonic basin 302.

A water connection (via which water can be refilled in the ultrasonic basin 302), a fill level indicator/measurement, and a temperature measurement/controller having temperature sensor in the ultrasonic basin 302 are also provided in the ultrasonic basin 302. Further testing and analysis devices for testing the state of the cleaning liquid, such as a refractometer or for determining the pH value, can be advantageous. The testing and analysis devices can be operated manually or in an automated manner.

A drying system 304—for drying the cleaned tools 4—is provided directly adjacent to the ultrasonic basin 302.

This drying system 304 combines a wet suction system with compressed air drying, which, on the one hand, suction off liquid/moisture from the tool 4 and, on the other hand, blow these off. Both in combination ensure the complete drying of the cleaned tools 4.

If a tool 4—before the shrinking—is now to be cleaned (here solely time-controlled cleaning process with specified cleaning times in the ultrasonic basin 302 and specified drying times in the drying system 304), the multiaxis articulated arm robot 10 grips (using its articulated/gripper arm 88) the tool 4 (from the conveyor box 200—cf. process step g)) and immerses it—held transversely—in the ultrasonic basin 302.

The tool 4 is cleaned by ultrasonic cleaning in the ultrasonic basin 302 while it continues to be held by the multiaxis articulated arm robot 10. The multiaxis articulated arm robot 10 now lifts the (now cleaned, but wet) tool 4 out of the ultrasonic basin 302—and moves it into the drying system, where—still held by the multiaxis articulated arm robot 10—it is dried by means of the combination of wet suction system with compressed air drying. The shrink chuck or other individual parts of a clamping chuck, such as clamping jaws and clamping nut, can also be cleaned analogously.

The multiaxis articulated arm robot 10 then “transfers” the (cleaned and dried) tool 4 further to a transfer unit, where it is gripped and held thereby, in this case the three-jaw chuck 96 (cf. FIGS. 12 and 13) (such that) functional areas and gripping areas (and also its total length and the like) on the tool 4 are visible and can be checked or measured (cf. above: (2) checking and validating a tool 4 which is to be shrunk (FIGS. 12 and 13), measurement system 94).

The tool 4—using the measurement system 94—can then be measured there (see above ibid.)—and its measurement data can be compared with data—stored for this tool and retrieved from a database.

Furthermore, the tool 4 can be displaced further from there by means of the gripping tower 12 or gripper device 22 thereon (clamping gripper 22) (cf. process step i)—see above). The centering station 56 (cf. process steps g), h), and i)) can be omitted.

### Conveyor Box or Transport Box 200 for the Transport of Toolholders 6 and Tools 4 (FIGS. 6 to 9)

FIGS. 6 to 9 show—in various views—a conveyor box or transport box 200 for the transport of toolholders 6 and tools 4 (only conveyor box 200 in short hereinafter), as can be used, for example, in the automated shrink cell 2—for the transport therein of toolholders 6 and tools 4 (in particular to or away from shrink device 8 therein, in particular to conveyor belt 34 therein)—(see above).

The conveyor box 200—shown here in FIGS. 6 to 9 having a received (rotation) tool 4, here a milling cutter 4, for example, and a received toolholder 6, here a shrink chuck 6, for example—provides an essentially cuboid main body 202.

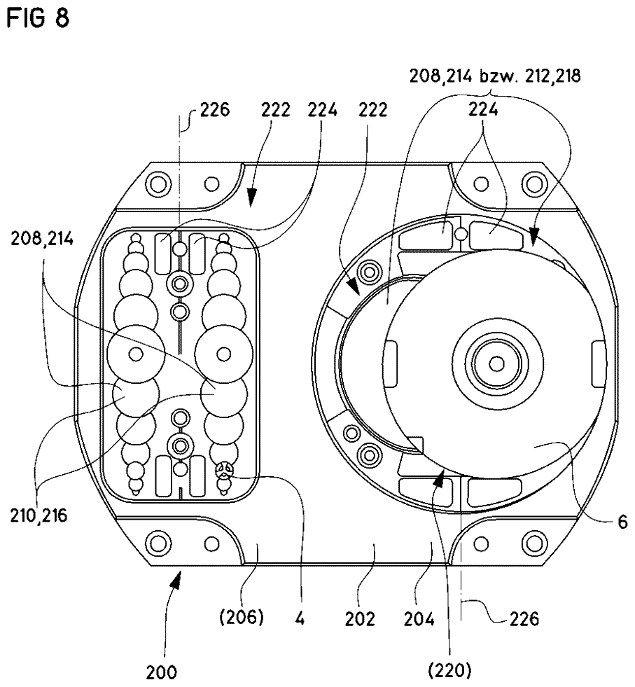

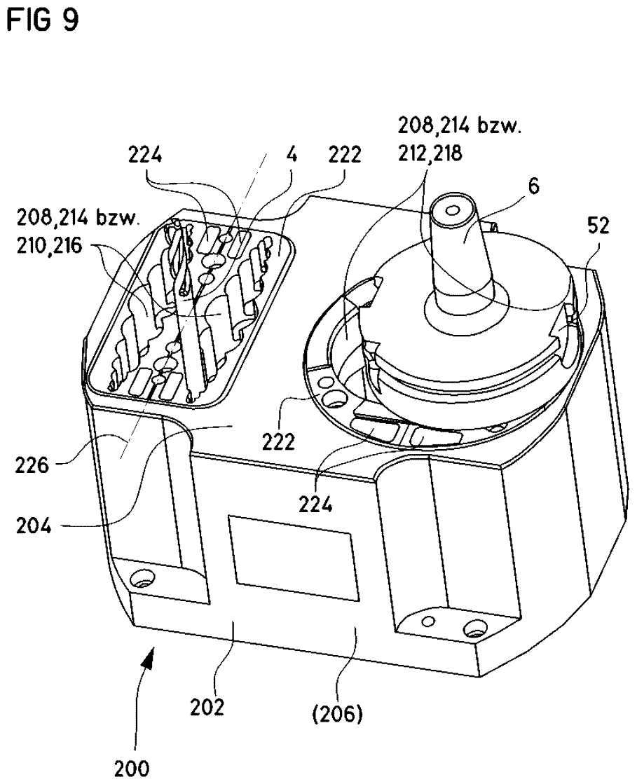

As FIGS. 8 and 9 show in particular, a plurality of cylindrical (i.e. essentially circular in diameter) receptacle openings 208, 210, 212, 214, 216, 218 for toolholders 6 and tools 4, which extend into an interior 206 of the main body 202, are arranged on an upper side 204 of the main body 202.

The—multiple—receptacle openings 210, 216 for the tools 4, as can likewise be seen in particular from FIGS. 8 and 9, are arranged here in a block 222 in a left half of the main body 202; the receptacle openings 212, 218 for the toolholders 212 are provided in a block 222 in the area of the right half of the main body 202.

As FIGS. 8 and 9 show in particular, each receptacle opening 208, 210, 212 comprises an identical (identically formed) receptacle opening 214, 216, 218 associated with it, each two such associated receptacle openings 208, 210, 212 and 214, 216, 218 being arranged in a mirror image in relation to one another in the main body 202 of the conveyor box 200.

Thus, as FIGS. 8 and 9 show in particular, the receptacle openings 210, 214 for the tools 4 are arranged in two opposite longitudinal rows which are in a mirror image or symmetrical with respect to an axis of symmetry 226.

This also applies accordingly for the receptacle openings 212, 218 of the toolholders 6, wherein in this case, as FIGS. 8 and 9 show, there are “only” two receptacle openings 212, 218, namely the first receptacle opening 212 and its associated—mirror-image or symmetrically arranged—“mirror image” 218.

The receptacle openings 210, 216 for the tools 4 have different diameters 26 (and depths 28) which are matched to tool diameters 26 (and tool lengths 28), so that a large number of tools 4 of different sizes can be received in the conveyor box 200.

As in particular FIGS. 8 and 9 furthermore also show, the two associated receptacle openings 212, 218 for a toolholder 6, i.e. the first receptacle opening 212 and its associated “mirror image” 218—arranged in a mirror image or symmetrically—are arranged overlapping 220.

This is space-saving, but enables with corresponding “small” overlap 220, a secure hold/a securely holding receptacle of a toolholder 6 in the conveyor box 220.

To be able to distinguish the receptacle openings 208, 210, 212, 214, 216, 218, namely, on the one hand, first receptacle openings 208, 210, 212 and, on the other hand, their associated identical mirror-image receptacle openings 214, 216, 218, a marking 224 in this regard is provided on the conveyor box 200 or at receptacle openings 208, 210, 212, 214, 216, 218 therein, which classifies the first receptacle openings 208, 210, 212 as the “good side” and their associated identical mirror-image receptacle openings 214, 216, 218 as the “bad side”.

With such an expedient modification of the conveyor box 200, markings and/or mechanical indexing elements can be provided, which ensure a location-oriented insertion/holding of the tools 4 and/or toolholders 6 (cf. above on the location-oriented insertion).

Although the invention was illustrated and described in more detail by the preferred exemplary embodiments, the invention is not restricted by the disclosed examples, and other variations can be derived therefrom without departing from the scope of protection of the invention.

Induction coil assembly, ultrasonic bath, and conveyor box can also be continued if needed as individual separate inventive subjects in the form of divisional applications.

The following is a summary list of reference numerals and the corresponding structure used in the above description of the invention:
2 shrink device (automated) shrink cell
4 tool, turning tool, rotation tool, milling cutter/milling tool, drill
6 toolholder, shrink receptacle/chuck
8 shrink device
10 first multiaxis handling device, multiaxis articulated arm robot
12 second automatically movable handling device, gripper tower
14 single-axis linear drive
16 Z axis
18 gripper head
20 angle measuring device
22 gripper device, clamping gripper
24 force measuring device, cell
26 (tool) diameter, diameter
28 (tool) length, depth
30 (movable, displaceable by electric motor) gripper jaw
32 stop lug
34 conveyor device, conveyor belt
36 spindle (of the shrink device 8)
38 induction coil assembly
40 horizontal
42 vertical
44 lifting travel monitoring device
46 vertical movement travel, raising travel
48 collision monitoring device
50 read unit/device, measurement laser
52 marking, toolholder code
54 centering station
56 centering jaw
58 alignment monitoring device, measurement system
60 measuring device/unit (tool measurement)
62 double gripper (for tool and toolholder)
64 cooling station
66 spindle (of the cooling station 64)
68 cooling attachment (can be slipped over, generating a turbulent flow cooling (cyclone cooling))
70 switch cabinet
72 balancing device
74 presetting device
76 control computer
78 control program, controller (on control computer 76)
80 safety shield, fence
82 environment
84 (safety) door (in 80)
86 segment (of 34)
88 articulated/gripper arm
90 positioning table
92 stop washer, ferrite washer, concentrator
94 (further) measuring unit, transmitted light measurement system
96 (further) holding device, rotatable jaw chuck, 3-jaw chuck
102 coil housing
104 winding body
106 (mechanical) contact switch (front)
108 (mechanical) contact switch (rear)
110 connection/plug elements
112 opening (for tool 8)
114 recess (for gripper device/clamping gripper 22)
116 gripping element (on the stop washer 92 for gripping of the stop washer 92 by the gripper device/the clamping gripper 22)
118 washer element (made of ferrite), ferrite washer/body
120 frame (of the washer element 118)
122 (left) screw connection (for fastening the induction coil assembly 38 on the carrier 126)
124 (right) screw connection (for fastening the induction coil assembly 38 on the carrier 126)
126 carrier (for induction coil assembly 38) (cf. FIG. 4)
128 (upper) fume extraction duct
130 (lower) fume extraction duct
132 groove
134 fume extraction
136 annular duct
138 openings in the annular duct 136
140 connection (for compressed air line for tool/toolholder cooling)
200 conveyor/transport box, conveyor/transport container
202 main body
204 upper side (of 202)
206 inner (of 202)
208 receptacle opening
210 receptacle opening for a tool
212 receptacle opening for a toolholder
214 mirror-image, identical receptacle opening
216 mirror-image, identical receptacle opening for a tool
218 mirror-image, identical receptacle opening for a toolholder
220 overlap (with two associated receptacle openings for a toolholder)
222 arrangement in a block
224 marking, good-bad marking
226 axis of symmetry
300 ultrasonic cleaning system
302 (ultrasonic cleaning) basin
304 drying system
400 (first) measured value course
402 (second) measured value course
404 mean value, arithmetic mean
406 value range
408 range (having the most successive measured values)
410 associated rotational position
412 further mean value, further arithmetic mean
414 outlier
416 middle
418 first error-compensated measured value
420 second error-compensated measured value

1. A method for compensating for measurement errors in a measurement of tools or workpieces, which comprises the steps of:
measuring a point on a tool or a workpiece that distinguishes the tool or the workpiece while the tool or the workpiece is rotated by a specifiable rotational angle around its longitudinal axis from a defined starting rotational position;
determining a mean value from measured values of a measured value course measured; and
determining an error-compensated measured value for the point distinguishing the tool or the workpiece from the mean value, namely using the measured values which meet a specifiable criterion with respect to the mean value.

2. The method for compensating for the measurement errors in the measurement of the tools or the workpieces according to claim 1, wherein:
a range having most successive said measured values, which meet the specifiable criterion with respect to the mean value, is determined in the measured value course; and
a measured value which lies at a specifiable position, namely in a middle of the range determined, is determined as the error-compensated measured value for the point distinguishing the tool or the workpiece.

3. The method for compensating for the measurement errors in the measurement of the tools or the workpieces according to claim 2, which further comprises determining for the measured value which lies in the middle of the range, or the error-compensated measured value, an associated rotational position thereof.

4. The method for compensating for the measurement errors in the measurement of the tools or the workpieces according to claim 1, which further comprises determining from the measured values which meet the specifiable criterion with respect to the mean value and lie within a specifiable value range around the mean value, a further mean value, the further mean value functions as a further error-compensated measured value for the point distinguishing the tool or the workpiece.

5. The method for compensating for the measurement errors in the measurement of the tools or the workpieces according to claim 4, wherein the specifiable value range lies asymmetrically around the mean value.

6. The method for compensating for the measurement errors in the measurement of the tools or the workpieces according to claim 1, which further comprises selecting the specifiable rotational angle from a range between 5° and 300°.

7. The method for compensating for the measurement errors in the measurement of the tools or the workpieces according to claim 1, which further comprises carrying out the measuring step using a telecentric measurement method.

8. The method for compensating for the measurement errors in the measurement of the tools or the workpieces according to claim 1, wherein at least one of the measured values or the measured value course is smoothed, filtered, and/or processed by another statistical method.

9. The method for compensating for the measurement errors in the measurement of the tools or the workpieces according to claim 1, which further comprises using the method in an automated process during machining of the tool or the workpiece.

10. The method for compensating for the measurement errors in the measurement of the tools or the workpieces according to claim 9, wherein the tool or the workpiece, in a further process step of the automatic process, is rotated into an associated rotational position or held in the associated rotational position and processed while thus held.

11. The method for compensating for the measurement errors in the measurement of the tools or the workpieces according to claim 1, which further comprises performing the method during an automated mounting, presetting or measuring of the tool or during balancing of the tool or a complete tool made up of a toolholder and the tool held in the toolholder.

12. The method for compensating for the measurement errors in the measurement of the tools or the workpieces according to claim 1, which further comprises performing the method for measuring a milling tool.

13. The method for compensating for the measurement errors in the measurement of the tools or the workpieces according to claim 1, which further comprises:
performing the method in an automated process using a shrink device for automated chucking and unchucking of the tool in a toolholder;
setting the point to be a highest point of the tool with respect to a longitudinal axis of the tool; and
determining the mean value as an arithmetic mean.

14. The method for compensating for the measurement errors in the measurement of the tools or the workpieces according to claim 1, wherein:
a range having most successive said measured values, which meet the specifiable criterion with respect to the mean value, being an arithmetic mean, which are less than the arithmetic mean, is determined in the measured value course; and
the measured value which lies at a specifiable position, namely a middle of the range, is determined as the error-compensated measured value for the point distinguishing the tool or the workpiece.

15. The method for compensating for the measurement errors in the measurement of the tools or the workpieces according to claim 1, which further comprises determining from the measured values which meet the specifiable criterion with respect to the mean value, being an arithmetic mean, and lie within a specifiable value range around the arithmetic mean, a further mean value, being a further arithmetic mean, the further mean value functions as a further error-compensated measured value for the point distinguishing the tool or the workpiece.

16. The method for compensating for the measurement errors in the measurement of the tools or the workpieces according to claim 4, wherein the specifiable value range lies asymmetrically around the mean value being an arithmetic mean.

17. The method for compensating for the measurement errors in the measurement of the tools or the workpieces according to claim 6, which further comprises selecting the range from the group consisting of between 45° and 270°, between 75° and 180°, and 90°.

18. The method for compensating for the measurement errors in the measurement of the tools or the workpieces according to claim 12, wherein the milling tool has at least one end blade.

19. A measuring device for measuring tools or workpieces, comprising:
a measuring unit having a telecentric measuring unit; and
a measurement error compensation device configured to carry out the method for compensating for measurement errors in the measurement of the tools or the workpieces according to claim 1.

20. A mounting device for automated chucking and unchucking of a tool in a toolholder, the mounting device comprising:
the measuring device for measuring the tools or the workpieces with measurement error compensation according to claim 19.
